(19) United States
(12) Patent Application Publication
(10) Pub. No.: US 2007/0258482 A1
(43) Pub. Date: Nov. 8, 2007

(54) Multi-Protocol Remote Control Device

(75) Inventor: Pieter Dingenis Griep, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,505

(22) PCT Filed: May 27, 2005
(86) PCT No.: PCT/IB05/51746

§ 371 Date: Nov. 22, 2006

(30) Foreign Application Priority Data
Jun. 1, 2004 (EP) 04102433.2

(51) Int. Cl. H04J 3/16

(52) U.S. Cl. 370/466

(57) ABSTRACT

A control device (10) is provided for control of an apparatus (12). The device is configured for communication with the apparatus using a one-way protocol or a two-way protocol. The device is configured to communicate a message for triggering a response from the apparatus, and to continue (31, 32; 608, 610) to communicate with the apparatus using the two-way protocol upon receipt of the response within a predetermined time interval, and to continue (33, 34, 35; 602, 604) to communicate with the apparatus using the one-way protocol in the absence of the response within the time interval.

### FIELD OF THE INVENTION

The invention relates to a control device for controlling equipment, e.g., consumer electronics (CE) equipment, preferably through wireless communication using, e.g., infrared (IR) or radio frequency (RF). The invention further relates to control software for installing on such as control device.

### BACKGROUND ART

Control of an apparatus through a remote control device requires an agreed control protocol that controls the generation and interpretation of control message signals by the remote control device and the apparatus, respectively. The protocol defines the relationship between commands and signal characteristics. In principle, this relationship can be chosen arbitrarily, as long as the remote control device and the apparatus comply with the same relationship. Accordingly, many different protocols exist. These include two-way protocols, in which the apparatus returns a response to the remote control device in reply to receiving a command from the remote control device. A two-way protocol is known from, for example, Japanese Patent Application, publication number 2000-196654. However, protocols for remote control devices are typically one-way protocols, under which messages are transmitted only from the remote control device to the apparatus and not the other way round.

It is desirable that the same remote control device be suitable for control of different apparatus, even if these apparatus use different control protocols. Accordingly, multi-protocol remote control devices have been developed. The simplest example thereof is a remote control device with different function buttons for commands according different protocols (for a television set and for a video recorder of different manufacturers, for example). However, in a truly multi-protocol remote control device the command message transmitted in response to actuation of the same function button at the remote control device depends on a state of the remote control device. The state determines the selected protocol. One example of such a truly multi-protocol remote control device has one or more control buttons for switching between different states and, therefore, between different protocols. Typically, the user uses the control button for state selection when he/she installs an apparatus, in order to configure the remote control device into the state that results in control messages according to the relevant protocol.

In theory, this type of multi-protocol remote control device could also be used to control different apparatus alternately, if the apparatuses require different protocols. However, this is cumbersome because it requires the user to select and actuate a control button to switch states each time when a different apparatus must be controlled.

### OBJECT OF THE INVENTION

Among other things, it is an object of the invention to provide for a remote control device that facilitates switching between different protocols.

### SUMMARY OF THE INVENTION

To this end, the invention provides a control device, e.g., a remote control device for wireless communication, for control of an apparatus, e.g., a consumer electronics (CE) appliance. The device is configured for communication with the apparatus using a one-way protocol or a two-way protocol. The device is configured to communicate a message for triggering a response from the apparatus, and to continue to communicate with the apparatus using the two-way protocol upon receipt of the response within a predetermined time interval, or to continue to communicate with the apparatus using the one-way protocol in the absence of the response within the time interval.

Preferably, the device has a user interface, and the device initiates the communication upon an input through the user interface after a further time interval has elapsed during which the input was absent. In an embodiment of the invention, the device initiates the communication with the message according to the two-way protocol. Alternatively, the device initiates the communication with the message according to the two-way protocol appended to a further message according to the one-way protocol. The user interface registers an input at actuation of the user interface, and the message is appended to the further message upon termination of the actuation.

The control device in the invention automatically detects whether the controllable apparatus is capable of two-way communication without user intervention. For example, upon a reset (e.g., at battery insertion) the control device enters the idle state in the one-way communication mode. Then, at a key press, the control device enters the transmitting state in the one-way communication mode. In this state, the control message corresponding to the key pressed is transmitted to the apparatus using a, possibly proprietary, one-way protocol. Upon key release, a probe message is transmitted that probes whether the apparatus is capable of two-way communication. The control device enters the detection state of the two-way communication mode awaiting a response from the apparatus. If the apparatus is not capable of two-way communication, e.g., because it is an older (legacy) apparatus, the apparatus cannot respond to the probe message. Upon elapse of a first timeout interval the control device returns to idle state of the one-way communication mode, for using the (legacy) one-way communication only, for the time being. If, however, the apparatus is two-way communication-enabled, it returns a response to the probe message within the first timeout interval. When the control device detects the response within the first timeout interval, the device configures itself for the two-way communication, based upon the information received from the apparatus in the response to the probe message. For example, the control device has a display monitor (e.g., a touch screen) and sets up the proper graphical user interface (GUI) for control of the apparatus. After this setup stage, the device enters the idle state of the two-way communication mode. Then at a next key press, the control device enters the communication state of the two-way mode and uses the two-way communication protocol for the time being. If a second timeout interval has elapsed wherein keys have not been pressed, the device returns to the idle state of the one-way mode described above.

Considering an embodiment of the remote control device in the invention, it has at least a two-way mode, wherein actuation of a function button causes a control message to be transmitted according to the two-way protocol, and a second one-way mode wherein actuation of the same function button causes a control message to be transmitted according to the one-way protocol. In the second one-way mode, additional messages according to the two-way protocol are sent in response to actuation of control buttons of the remote control device. Typically, the control message and the additional messages are sent via the same wireless medium, preferably sharing the same transmitter on the remote control device, such as an IR-transmitter or an RF-transmitter.

Time-out periods are used to detect whether an apparatus responds to the control message and additional messages according to the two-way protocol. If a response is not detected in the two-way mode, the remote control device switches to the one-way mode. If the response is detected in the two-way mode the remote control device switches to the two-way mode (or remains in the two-way mode). Preferably, in contrast to the one-way mode, no messages according to the one-way protocol are sent in the two-way mode in response to actuation of control buttons. This saves power and leaves more time for sending control messages according to the two-way protocol, which is useful if the messages according to the one-way protocol take more time than the messages according to the two-way protocol.

In an embodiment the control message according to the one-way protocol is triggered pushing a button on the remote control device and the corresponding additional message according to the two-way protocol is triggered by release of that button. This makes it possible to send a maximum of repeated command messages according to the one-way protocol while the button remains pressed, which increases the probability that the command will be received.

The additional message sent in the one-way mode is preferably a command message that is the functional equivalent (has the equivalent effect when executed by the controlled apparatus) of the command message according to the one-way protocol. Thus no further message is needed to execute the command. However, instead, the additional message may be a probe message, which is not specific to the selected command, particularly if the selected command does not lead to a response message from the controlled apparatus even according to the two-way protocol. The controlled apparatus is designed so that the probe message is ensured to elicit a response.

The invention also relates to control software for being installed at a programmable control device for control of an apparatus. The software is operative to configure the device for communication with the apparatus using a one-way protocol or a two-way protocol. The software configures the device to communicate a message for triggering a response from the apparatus, and to continue to communicate with the apparatus using the two-way protocol upon receipt of the response within a predetermined time interval or to continue to communicate with the apparatus using the one-way protocol in the absence of the response within the time interval. This embodiment is particularly interesting to programmable universal remote control devices. The invention enables to have the remote control device operate with two-way-enabled appliances as well as with legacy appliances that are capable of one-way control only.

### BRIEF DESCRIPTION OF THE DRAWING

The invention is described in further detail below, by way of example and with reference to the accompanying drawings, wherein:

FIG. 1 is a diagram of a system containing an apparatus and a remote control device;

FIG. 2 is a block diagram of a remote control device;

FIG. 3 is a state-chart of operation of a remote control device;

FIGS. 4 and 5 are diagrams of signals used in operation of a remote control device; and

FIG. 6 is another state chart.

### DETAILED EMBODIMENTS

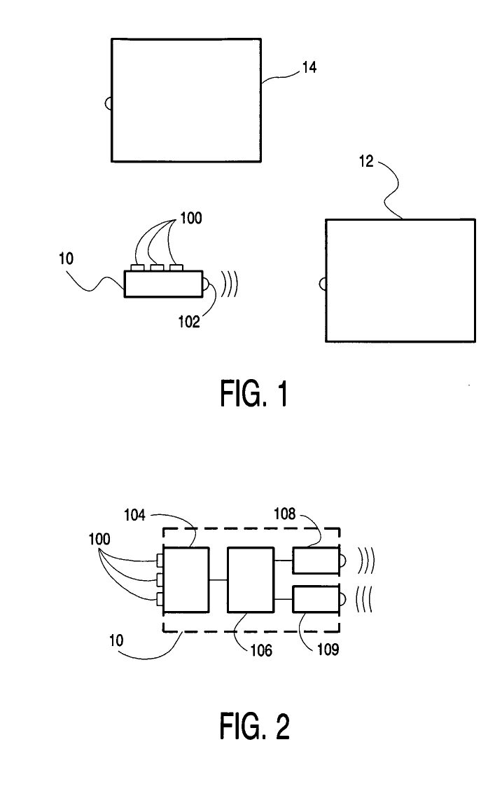

FIG. 1 is a diagram of a system, for example a home-based system with consumer electronics (CE) equipment. The system comprises first and second controllable apparatus 12 and 14, and a remote control device 10. Device 10 has a plurality of control buttons 100 and transmitter/receiver elements 102 (only one shown). Typically, transmitter/receiver elements 102 comprise an infrared source (e.g., an LED) and an infrared receiver. Other types of transmitters/receivers can be used, e.g., based on ultrasound or RF, or combinations thereof or with IR. Apparatus 12 and 14 each have a corresponding receiver, and possibly also a transmitter if the relevant one of apparatus 12 and 14 is two-way enabled. Typically, apparatus 12 and apparatus 14 are located in different rooms, or at such a distance from one another that device 10 can be used to send messages to a single one of apparatus 12 and 14 at a time. Apparatus 12 and 14 require control messages according to different protocols, e.g., a two-way protocol in which one of apparatus 12 and 14 responds to messages received by sending back another message, and a one-way protocol in which the other one of apparatus 12 and 14 merely receives messages and is not configured to return a response message to control device 10.

FIG. 2 is a diagram of remote control device 10, having buttons 100, a button interface circuit 104, a control circuit 106, a transmitter circuit 108 and a receiver circuit 109. Control circuit 106 is coupled to buttons 100 via button interface circuit 104, and to transmitter circuit 108 and receiver circuit 109.

In operational use, circuit 104 senses whether and, if so, which one of buttons 100 has been actuated. In response to actuation of a specific one of buttons 100, circuit 106 generates logic signals that represent a command message associated with the specific button actuated. The logic signals are supplied to transmitter circuit 108, which controls transmission element 102 to transmit an infrared pulse pattern (or other signal) to, e.g., apparatus 12.

Device 10 is configured to send command messages to apparatus 12 according to at least two protocols: a one-way protocol and a two-way protocol. Protocols of this type are known per se. Typically, a protocol defines commands in terms of respective successions of logical bits, and pulse patterns that represent these bits, e.g., in terms of the duration of the pulses. Different protocols may use different successions of bits, different pulse patterns, different pulse durations, etc.

A first protocol supported by device 10 is a one-way protocol, wherein communication between device 10 and a controllable apparatus merely involves a transmission of a command message from device 10 to the apparatus. The apparatus then does not respond by returning a message to control device 10.

A second protocol supported by device 10 is a two-way protocol, wherein communication of a command from device 10 to a controllable apparatus involves a bi-directional exchange of messages between device 10 and the apparatus. For example, a command message from device 10 is followed by an acknowledgement from the apparatus, and/or by a message for controlling display of information at the LCD of device 10, for example, by way of visual feedback to the user.

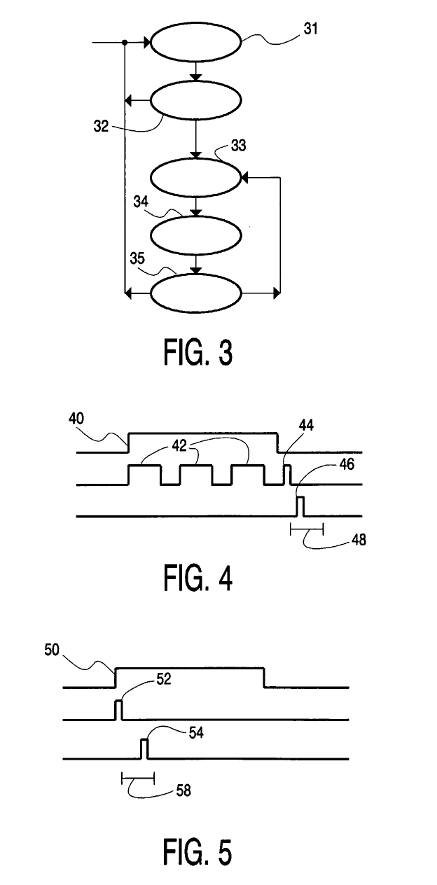

FIG. 3 is a state-chart that illustrates how control circuit 106 switches between different protocols. The state chart represents various states of the operational modes of device 10, corresponding to the two-way protocol and the one-way protocol. States 31 and 32 are representative of the mode of operation under the two-way protocol. States 33, 34, and 35 are representative of the mode of operation under the one-way protocol. When device 10 is reset (e.g., on insertion of batteries, or in response to actuation of a reset button, or power-on), circuit 106 enters state 31. In state 31, circuit 106 waits for actuation of a control button 100. If button 100 is pressed, circuit 106 transits to state 32, in which it generates a control message associated with the specific button pressed and according to the two-way protocol. Circuit 106 causes transmitter circuit 108 to transmit the control message according to the two-way protocol and waits whether receiver circuit 109 indicates reception of a response message from apparatus 12. On receipt of the response message within a time-out interval of predetermined duration, control circuit 106 returns to state 31. If there is no reception indicated of a response signal within the time-out interval, control circuit 106 transits to state 33.

FIG. 5 further illustrates operation. Time runs from left to right. A first trace 50 indicates pressing of the button 100. A low level indicates that the button is not pressed and a high level indicates a pressed button. A second trace, including pulse 52, indicates that transmitter circuit 108 is sending signals. Pulse 52 represents a control message associated with the pressed button 100, according to the two-way protocol that is sent in response to pressing of the button. A second pulse 54 represents reception of a response message. If such a response message is not received within time-out interval 58 after transmission of the control message 52, control circuit 106 transits to state 33.

In state 33, control circuit 106 waits for a next button 100 to be pressed. When button 100 is being pressed, control circuit 106 transits to state 34, in which control circuit 106 generates a control message, associated with the button pressed. Also in state 34, circuit 106 causes transmitter circuit 108 to transmit the generated control message encoded and transmitted according to the one-way protocol. Optionally, control circuit 106 causes transmitter circuit 108 to repeat transmission of the control message as long as the button remains pressed.

When the button 100 is released, control circuit 106 transits to state 35, wherein control circuit 106 first generates an additional message and causes transmitter circuit 108 to transmit the compound control message. The additional message is encoded and transmitted according to the two-way protocol. In one embodiment, the additional message is a probe message, which is not specific to the button 100 that has been actuated. In another embodiment the additional message is selected dependent on the button 100, so that it is functionally equivalent to the control message of the one-way protocol. After transmission of the additional message control circuit 106 waits for a time-out period of predetermined length, monitoring whether receiver circuit 109 indicates reception, from apparatus 12, of a response to the additional message. If no reception is indicated, control circuit returns to state 33. If reception is indicated, control circuit returns to state 31.

FIG. 4 illustrates signals transmitted in these sub-states. A first trace 40 indicates pressing of the button 100. A low level indicates that the button is not pressed a high level indicates a pressed button. A second trace indicates signals transmitted by transmitter circuit 108. First pulses 42 represent repeated control messages, dependent on the pressed button 100, according to the one-way protocol that are sent while the button remains pressed. A second pulse 44 represents transmission of the additional message according to the two-way protocol once the button 100 is released. During interval 48 after transmission of this additional message control circuit waits for reception of a response from apparatus 12. The Figure shows the case that such a response message 46 is received. In the absence of such a response message in time interval 48 control circuit 106 returns to state 33. Control circuit 106 enters state 34 if a response message 46 is received.

As will be appreciated, device 10 thus effectively supports two modes: in a first mode, represented by states 31 and 32, each actuation of a button 100 results in transmission of a two-way control message. In a second mode represented by states 33, 34 and 35, the actuation of a button 100 results in transmission of one or more one-way control messages and an additional two-way message. Transitions between the modes occur dependent on reception of response messages in time-out intervals.

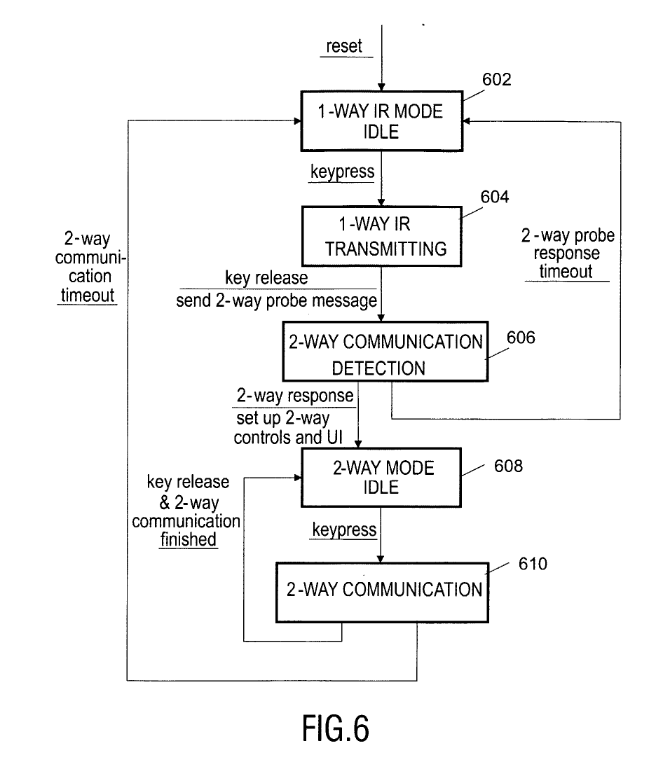

FIG. 6 is a state chart of an alternative embodiment of control device 10. Upon a reset (e.g., at battery insertion) control device 10 enters an idle state 602 in the one-way communication mode. Then, at a key press, control device 10 enters a transmitting state 604 in the one-way communication mode. In state 604, the control message corresponding to the key pressed is transmitted to apparatus 12 using a, possibly proprietary, one-way protocol. Upon key release, a probe message is transmitted that probes whether apparatus 12 is capable of two-way communication. Control device 10 enters a detection state 606 of the two-way communication mode awaiting a response from apparatus 12. If apparatus 12 is not capable of two-way communication, e.g., because it is an older (legacy) apparatus, apparatus 2 cannot respond to the probe message. Upon elapse of a first timeout interval control device 10 returns to idle state 602 of the one-way communication mode, for using the (legacy) one-way communication only, for the time being. If, however, apparatus 12 is two-way communication-enabled, it returns a response to the probe message within the first timeout interval. When control device 10 detects the response within the first timeout interval, device 10 configures itself for the two-way communication, based upon the information received from apparatus 12 in the response to the probe message. For example, control device 10 has a display monitor (e.g., a touch screen) and sets up the proper graphical user interface (GUI) for control of apparatus 12. After this setup stage, device 10 enters an idle state 608 of the two-way communication mode. Then at a next key press, control device 10 enters a communication state 610 of the two-way mode and uses the two-way communication protocol for the time being. If a second timeout interval has elapsed wherein keys have not been pressed, device 10 returns to idle state 602 of the one-way mode described above. The probe message referred to above may be sent only once at initiating the control session. When the session has terminated and a new session starts, the probe message may be sent again. In order to distinguish different control sessions, a timer can be used to determine whether a key was pressed within a predetermined time period. If pressed, the current session has not terminated. Note that in the diagram of FIG. 5 the probe message may be a control command of the two-way communication protocol that triggers a response if received by a compliant apparatus.

Although the invention has been described for a specific embodiment, it will be appreciated that the invention is not limited to this embodiment. For example, without deviating from the invention a plurality of repeated control messages 52 according to the two-way protocol may be transmitted while the button 100 remains pressed in the second state, until a response message is received from apparatus 12 (e.g. within the time out interval 58) or until the button 100 is released. In this embodiment control circuit transits to state 33 when the button 100 is released if no response message is received within any predetermined time-out interval after the repeated messages. This reduces the probability of state switching due to accidentally mis-received messages. Similarly, instead of waiting for release of the button a predetermined number of repeated control messages may be sent before transiting to the state 33. Similarly, a plurality of two-way additional messages 44 may be sent in state 35, and a transition to state 31 may be performed if a response message is received in a time-out interval after any of these messages. This also this reduces effect of mis-reception.

As a further alternative, additional messages according to a plurality of different two-way protocols may be sent in state 35, the control circuit 106 selecting one of these two-ways protocols for use in the state 31, dependent on the two-way protocol for which a response was received to the additional message.

Furthermore, without deviating from the invention control circuit 106 may be arranged to cause transmission of a command message according to the one-way protocol, selected dependent on the pressed button, when transiting to the state 33. This increases the probability that the command will be executed without need to push the button again. Preferably transmission of this one-way control message is repeated until the button 100 is released.

Preferably, control circuit 106 causes a functional, pressed button dependent two-way control message to be sent as additional message in state 35. Optionally, if some control messages of the two-way protocol do not result in a response message, a probe signal, which does elicit a response signal is substituted as additional message in this case. In an alternative embodiment the additional message is always the same type of probe message, independent of the pressed button. This reduces overhead.

In principle, control circuit 106 may be configured to retain its state indefinitely, represented, e.g., by state information in a memory (not shown) in circuit 106. In an embodiment, however, the state may be reset under certain conditions, e.g., if no button 100 is actuated for a predetermined time interval of, for example, one or a few hours, or when the batteries (not shown) of device 10 have been replaced, or when a reset button on device 10 is actuated. Preferably, the state is reset to state 31, but alternatively the state may be reset to state 33 so that circuit 106 starts operating in the second mode.

Although the invention has been described using “buttons” that are pressed and released it will be appreciated that the control buttons of remote control device may for example be implemented as touch sensitive surfaces, or as a touch screen. Control circuit 106 may be implemented as a suitably programmed programmable processor, or as a dedicated, hardwired circuit. The generation of messages may include algorithmic generation, or simple reading from a table of predetermined messages. Although predetermined first and second protocols have been used, it will be understood that without deviating from the invention remote control device 10 may be arranged to program the protocols that will be used in the different states and/or the protocol to which device 10 will reset.

1. A control device (10) for control of an apparatus (12), wherein:
the device is configured for communication with the apparatus using a one-way protocol or a two-way protocol;
the device is configured to communicate a message for triggering a response from the apparatus, and to continue (31, 32; 608, 610) to communicate with the apparatus using the two-way protocol upon receipt of the response within a predetermined time interval or to continue (33, 34, 35; 602, 604) to communicate with the apparatus using the one-way protocol in the absence of the response within the time interval.

2. The device of claim 1, wherein:
the device has a user interface; and
the device initiates the communication upon an input through the user interface after a further time interval has elapsed during which the input was absent.

3. The device of claim 2, wherein the device initiates the communication with the message according to the two-way protocol.

4. The device of claim 2, wherein the device initiates the communication with the message according to the two-way protocol appended to a further message according to the one-way protocol.

5. The device of claim 4, wherein the user interface registers an input at actuation of the user interface, and wherein the message is appended to the further message upon termination of the actuation.

6. The device of claim 1, comprising a remote control device for implementing the communication in a wireless fashion.

7. The device of claim 6, configured for control of consumer electronics equipment.

8. Control software for being installed at a programmable control device for control of an apparatus, wherein the software is operative to:
configure the device for communication with the apparatus using a one-way protocol or a two-way protocol;
configure the device to communicate a message that triggers a response from the apparatus, and to continue to communicate with the apparatus using the two-way protocol upon receipt of the response within a predetermined time interval or to continue to communicate with the apparatus using the one-way protocol in the absence of the response within the time interval.
